(19) United States
(12) Patent Application Publication
(10) Pub. No.: US 2026/0242973 A1
(43) Pub. Date: Aug. 20, 2026

(54) LAMINATED STRUCTURE AND METHOD FOR MANUFACTURING THE SAME

(71) Applicant: Murata Manufacturing Co., Ltd., Nagaokakyo-shi (JP)

(72) Inventors: Ryotaro NAMBA, Nagaokakyo-shi (JP); Yusuke Arakawa, Nagaokakyo-shi (JP)

(21) Appl. No.: 19/642,847

(22) Filed: Apr. 9, 2026

Related U.S. Application Data
(63) Continuation of application No. PCT/JP2024/038953, filed on Oct. 31, 2024.

(30) Foreign Application Priority Data
Nov. 6, 2023 (JP) 2023-189651

(51) Int. Cl. C25D 5/56; C23F 17/00

(52) U.S. Cl. CPC C25D 5/56; C23F 17/00

(57) ABSTRACT

A laminated structure is provided that can be manufactured without using any chemical liquid with a strong oxidizing power and that has high adhesion between a resin substrate and a metal layer. The laminated structure includes a resin substrate including a substrate body and a modified layer that covers a surface of the substrate body; and a metal layer that covers a surface of the modified layer. A surface of the modified layer has an oxygen element concentration of 17 atom % or more and 30 atom % or less. In a sectional view, the modified layer has a needle-like structure on the surface.

### CROSS REFERENCE TO RELATED APPLICATIONS

This application is a continuation of International Application No. PCT/JP2024/038953, filed Oct. 31, 2024, which claims priority to Japanese Patent Application No. 2023-189651, filed Nov. 6, 2023, the entire contents of each of which are hereby incorporated by reference in their entirety.

### TECHNICAL FIELD

The present disclosure relates to a laminated structure including a resin substrate and a metal layer, and a method for manufacturing the laminated structure.

### BACKGROUND

Establishing a technique of coating a resin substrate with a metal layer such as a plating layer enables replacing a part of a product conventionally produced only with a metal material by a resin material, and provides various advantages such as weight reduction of the product, cost reduction therefor, improved degree of freedom for the shape thereof, and facilitation of mass production thereof.

Meanwhile, the adhesion between a resin substrate and a metal layer (particularly, a plating layer) is known to be low. Generally, the improvement measure most frequently used for improving the adhesion between a resin substrate and a plating layer is to roughen the surface of the resin substrate, as described in Patent Documents 1 to 4 identified below.

For example, Patent Document 1 discloses treating a plastic with an etching treatment liquid containing a permanganate and an inorganic acid, before the plastic is subjected to metal plating.

Moreover, Patent Document 2 discloses, as a pretreatment method for electroless plating on a surface of a polycarbonate molded article, immersing the polycarbonate molded article in an alkaline aqueous solution and then treating the surface of the polycarbonate molded article with the use of a hydrogen carbonate compound aqueous solution and ozone.

Patent Document 3 discloses, in a resin plating treatment method in which a syndiotactic polystyrene-based resin is subjected to electroless plating and then subjected to resin plating by electrolytic plating, applying an ozone water treatment of bringing the syndiotactic polystyrene-based resin into contact with an ozone aqueous solution, as a plating pretreatment in place of chromic acid etching or the like.

Patent Document 4 discloses a plating pretreatment method for a surface of an ABS-based resin, in which the ABS-based resin is treated with a solution containing a persulfuric acid obtained by electrolyzing only a sulfuric acid.

In addition, techniques have been described for improving the adhesion between a resin substrate and a plating layer by a method other than roughening a surface of a resin substrate, for example, as described in Patent Documents 5 to 8, which are identified below.

For example, Patent Document 5 discloses a method for forming a functional film on a resin product by (1) a step of introducing an acidic group into the resin product, (2) a step of treating the resin product from the step (1) with a metal ion-containing liquid, and (3) a step of reductively treating the resin product from the step (2) to form a metal film on the resin product.

Moreover, Patent Document 6 discloses an etching treatment with an ethyl alcohol solution containing ammonia in a step of etching a surface of a polyethylene terephthalate resin, applying a catalyst, and then performing electroless copper plating. As described therein, chemically dissolving and modifying the surface of the polyethylene terephthalate resin strengthens the chemical adhesion force between the metal and the surface of the object to be plated, thereby improving the adhesion strength of the copper plating film.

Patent Document 7 further discloses a plated product including a substrate, a primer layer, a plating base coating film layer, and a metal plating film, for which the adhesion between the primer layer and the plating base coating film layer is improved by controlling the type and content of the synthetic resin included in the plating base coating film layer.

Finally, Patent Document 8 discloses drying and curing a synthetic resin latex to form a primer layer on a surface of an electrically nonconductive substrate, then forming a catalytic metal layer on the primer layer and subjecting the catalytic metal layer to electroless plating to form a metal plating layer.
Patent Document 1: Japanese Patent Application Laid-Open No. 2008-31513
Patent Document 2: Japanese Patent Application Laid-Open No. 2002-121678
Patent Document 3: Japanese Patent Application Laid-Open No. 2012-52214
Patent Document 4: Japanese Patent No. 6953484
Patent Document 5: Japanese Patent No. 3475260
Patent Document 6: Japanese Patent Application Laid-Open No. H7-180062
Patent Document 7: Japanese Patent No. 5780635
Patent Document 8: Japanese Patent Application Laid-Open No. 2001-107257

One problem with the techniques for roughening resin substrate surfaces, which are disclosed in Patent Documents 1 to 4, is using the chemical liquid with a strong oxidizing power may influence the environment and cause problems with waste liquid treatment. Moreover, for the techniques of treating resin substrate surfaces, which are disclosed in Patent Documents 5 to 8 provide, although no such a chemical liquid is used, unstable adhesion strength between the resin substrate and the metal layer may occur, which may lead to failing to improve the adhesion between the substrate and the layer.

### SUMMARY OF THE INVENTION

Accordingly, it is an object of the present disclosure to provide a laminated structure that can be manufactured without using any chemical liquid with strong oxidizing power and that has high adhesion between a resin substrate and a metal layer. Moreover, it is another object of the present disclosure to provide a method for manufacturing the laminated structure.

According to an exemplary aspect of the present disclosure, a laminated structure is provided that includes a resin substrate including a substrate body and a modified layer that covers a surface of the substrate body; and a metal layer that covers the surface of the modified layer. The surface of the modified layer has an oxygen element concentration of 17 atom % or more and of 30 atom % or less. Moreover, in a sectional view, the modified layer has a needle-like structure.

In another exemplary aspect of the present disclosure, a method for manufacturing a laminated structure is provided. In this aspect, the method includes treating a surface of a resin substrate to form a surface-treated resin substrate that includes a substrate body and a softened layer that covers the substrate body; heat-treating the surface-treated resin substrate to cure the softened layer and form a modified layer; dissolving a part of a surface of the modified layer to form a needle-like structure; and forming a metal layer on a surface of the modified layer including the needle-like structure by a plating method. In this aspect, the modified layer has an oxygen element concentration of 17 atom % or more and of 30 atom % or less.

According to the exemplary aspects of the present disclosure, a laminated structure is provided that can be manufactured without using any chemical liquid with a strong oxidizing power and that has high adhesion between a resin substrate and a metal layer. Moreover, a method for manufacturing the laminated structure is also provided.

### BRIEF DESCRIPTION OF DRAWINGS

FIG. 1 is a schematic perspective view of a laminated structure according to an exemplary embodiment.

FIG. 2A is a schematic enlarged sectional view of the laminated structure in a section along line X-X in FIG. 1.

FIG. 2B is a schematic enlarged sectional view of an enlarged part of the laminated structure shown in FIG. 2A.

FIG. 3A is a schematic enlarged sectional view for explaining a method for manufacturing a laminated structure according to an exemplary embodiment.

FIG. 3B is a schematic enlarged sectional view for explaining the method for manufacturing a laminated structure according to an exemplary embodiment.

FIG. 3C is a schematic enlarged sectional view for explaining the method for manufacturing a laminated structure according to an exemplary embodiment.

FIG. 3D is a schematic enlarged sectional view for explaining the method for manufacturing a laminated structure according to an exemplary embodiment.

FIG. 4A is a TEM image showing a needle-like structure formed on a surface of a modified layer of a laminated structure.

FIG. 4B is a TEM image showing a needle-like structure formed on a surface of a modified layer of a laminated structure.

FIG. 4C is a TEM image showing a needle-like structure formed on the surface of the modified layer of the laminated structure.

FIG. 5 shows element mapping of an O (oxygen) element in TEM-EDX for the laminated structure.

The present inventors have diligently conducted studies for improving the adhesion between a resin substrate and a metal layer in a laminated structure obtained by lamination of the resin substrate and the metal layer. As a result, the present inventors have found for the first time that the adhesion between the metal layer and the resin substrate can be improved by increasing the oxygen element concentration at the surface of the resin substrate in contact with the metal layer and having a needle-like structure at the surface.

A laminated structure according to an exemplary embodiment and a method for manufacturing the laminated structure will be described below with reference to the drawings.

### EXEMPLARY EMBODIMENT

### (Laminated Structure 10)

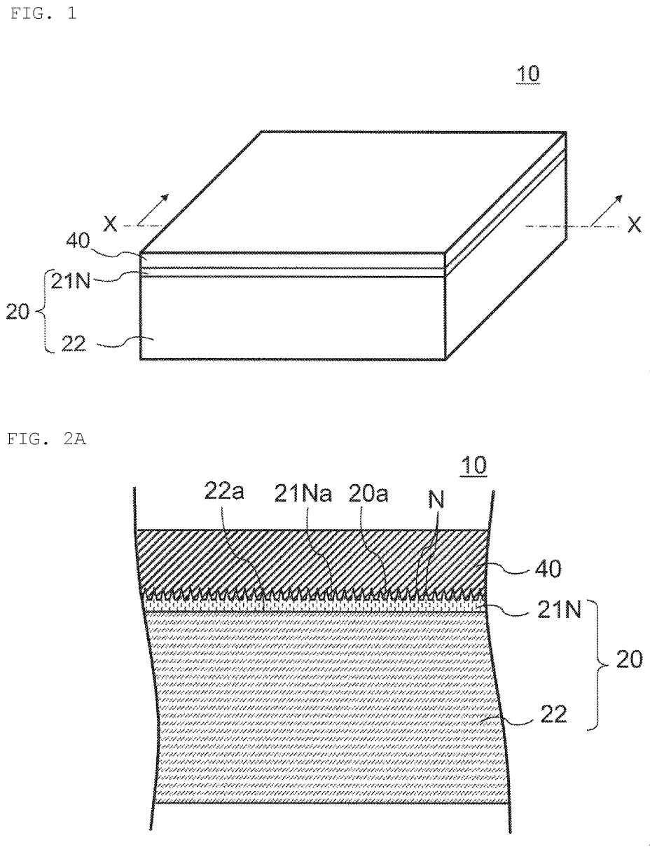

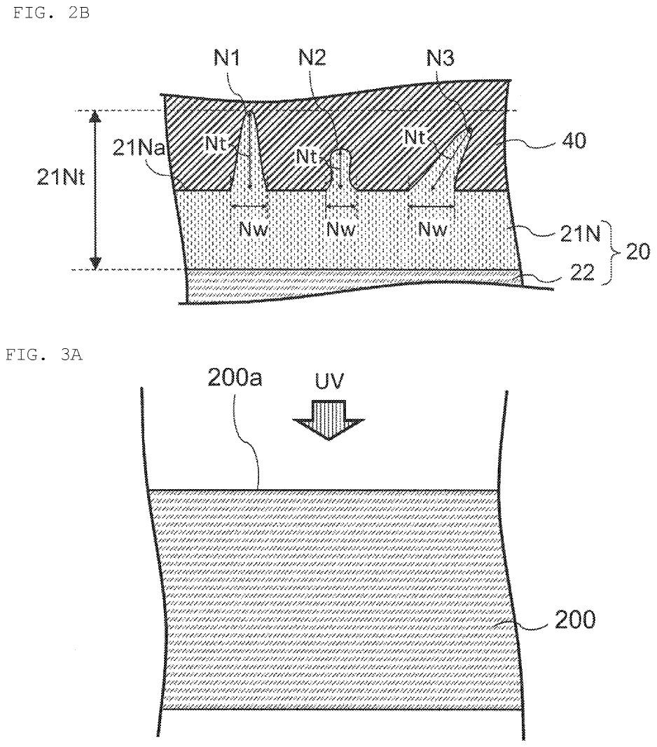

FIG. 1 is a schematic perspective view of a laminated structure 10 according to an exemplary embodiment, FIG. 2A is a schematic enlarged sectional view of the laminated structure 10 in a section along the line X-X in FIG. 1 (a section in the thickness direction of a resin substrate 20), and FIG. 2B is a schematic enlarged sectional view of an enlarged part of FIG. 2A.

As shown in FIGS. 1 and 2A, the laminated structure 10 includes the resin substrate 20 and a metal layer 40 provided on a surface 20a of the resin substrate 20. The resin substrate 20 includes a substrate body 22 and a modified layer 21N that covers a surface 22a of the substrate body 22. According to the exemplary aspect, the surface 22a of the substrate body 22 is entirely covered with the modified layer 21N but may be partially covered in alternative aspects.

Moreover, in the example of the laminated structure 10 shown in FIG. 2A, the surface 22a of the substrate body 22 is entirely covered with the modified layer 21N. The modified layer 21N is located on the side with the surface 20a of the resin substrate 20, and the surface 21Na of the modified layer 21N coincides with the surface 20a of the resin substrate 20. Accordingly, the metal layer 40 covers the surface 21Na of the modified layer 21N. The surface 20a of the resin substrate 20 is preferably entirely covered with the metal layer 40 but may be partially covered in an alternative aspect.

According to an exemplary aspect, the oxygen element concentration of the surface 21Na of the modified layer 21N is 17 atom % or more and 30 atom % or less. Moreover, the oxygen element concentration (atom %) is an element concentration of oxygen in the case of defining the total element concentration of oxygen (O), carbon (C), nitrogen (N), and copper (Cu) at the surface 21Na of the modified layer as 100 atom %.

The oxygen element concentration within this range indicates that an oxygen-based functional group is present in an appropriate amount at the surface 21Na of the modified layer 21N. The oxygen-based functional group forms a chemical bond with the metal layer 40 covering the surface 21Na of the modified layer 21N, and thus, the presence of the oxygen-based functional group in an appropriate amount at the surface 21Na is considered capable of enhancing the adhesion between the resin substrate 20 and the metal layer 40.

It is noted that if the oxygen element concentration is less than 17 atom %, the adhesion between the resin substrate 20 and the metal layer 40 may possibly be insufficiently improved.

On the other hand, if the oxygen element concentration exceeds 30 atom %, the strength of the modified layer 21N may possibly be decreased for the following reason.

The oxygen element is introduced in breaking a chemical bond of the polymer in the resin in a surface treatment step (details will be described later). Thus, the oxygen element concentration of the modified layer 21N of the laminated structure 10 is an index for knowing the degree of breaking the chemical bond of the molecular chain by employing the surface treatment step.

A heat treatment step that is performed after the surface treatment step can recombine the broken chemical bond and further form a new chemical bond. Thus, as long as the degree of chemical bond breakage by the surface treatment is appropriate, the strength of the modified layer 21N can be sufficiently recovered through the heat treatment, and furthermore, the strength can be improved. However, if the chemical bond is excessively broken by the surface treatment, the molecular weight is excessively reduced by oxygen introduction and bond dissociation, thereby decreasing the resistance to heat. Thus, if any heat treatment is performed, the strength of the modified layer 21N can be insufficiently recovered.

The oxygen element concentration of 30 atom % or less can be assumed to be the fact that the chemical bond is appropriately broken by the surface treatment, and thus, the strength of the modified layer 21N can be kept from being decreased.

Various element concentrations at the surface 21Na of the modified layer 21N are measured by X-ray photoelectron spectroscopy (XPS). Qualitative/semi-quantitative analysis and chemical state analysis are performed, as measurement conditions for the XPS, with a rectangular range of 1000 μm×200 μm on the surface 21Na as a measurement region, with the use of an XPS spectroscopic analyzer (for example, Quantes manufactured by ULVAC-PHI, Inc.). In the analysis in which XPS is used, the analysis depth is typically several nm.

According to the exemplary aspect, the oxygen element concentration of the surface 21Na of the modified layer 21N is preferably higher than the oxygen element concentration of the substrate body 22. More specifically, it is determined that the modified layer 21N is formed by treating the surface 20a of the resin substrate 20 to increase the oxygen element concentration.

The oxygen element concentration of the surface 21Na of the modified layer 21N is higher than the oxygen element concentration of the substrate body 22, thereby achieving an effect of further increasing the adhesion between the resin substrate 20 and the metal layer 40 as compared with a case in which the metal layer 40 is directly formed on the surface of the substrate body 22.

In addition, the modified layer 21N has a higher oxygen element concentration throughout than the resin substrate 20. Therefore, the modified layer 21N can also be referred to as an “oxygen enrichment layer” in an exemplary aspect.

Further, as will be described later, a needle-like structure N is formed on the surface 21Na of the modified layer 21N. The needle-like structure N is also higher in oxygen element concentration than the resin substrate 20, and thus, is regarded as a part of the modified layer (oxygen enrichment layer) 21N. However, for purposes of this disclosure, the term “surface 21Na of the modified layer 21N” refers to a surface excluding the needle-like structure N.

The range of the modified layer 21N can be specified by the following method. First, the laminated structure 10 is cut in the thickness direction of the resin substrate 20, and from the cross section, a thin piece sample is prepared. Of the thin piece sample, the vicinity of the boundary between the resin substrate 20 and the metal layer 40 is mainly analyzed by TEM-EDX to acquire a TEM image and oxygen (O) element mapping. Approximate ranges of the respective layers (substrate body 22, modified layer 21N, and metal layer 40) are confirmed in the TEM image, then, a region that is high in oxygen element concentration is specified in detail within the range corresponding to the modified layer 21N on element mapping, and the modified layer (or oxygen enrichment layer) 21N is determined (a region sandwiched between broken lines in FIG. 5).

The thickness 21Nt (FIG. 2B) of the modified layer 21N is preferably 10 nm or more and 5000 nm or less. The thickness 21Nt of the modified layer 21N is confirmed from a TEM image at a magnification of 300,000 times. The thickness 21Nt is the “maximum dimension of the modified layer 21N” in the case of measuring in the thickness direction of the laminated structure 10 in an arbitrary field of view. Further, as shown in FIG. 5, the surface (e.g., interface with the metal layer 40) or the back surface (e.g., interface with the substrate body 22) of the modified layer 21N is not a flat surface in some cases. Also in such a case, the maximum dimension of the modified layer 21N specified in the oxygen (O) element mapping measured in an arbitrary visual field is defined as the thickness 21Nt of the modified layer 21N.

While measuring the thickness of the modified layer 21N can be obtained by one-time TEM-EDX measurement, the TEM-EDX measurement may be, for improving the measurement accuracy, performed at different positions (for example, two to six positions) of the thin piece sample, and the average thickness (21Ntₐᵥₑ) obtained by arithmetically averaging the obtained data on the thickness 21Nt of the modified layer 21N may be defined as the thickness of the modified layer 21N of the resin substrate 20 included in the laminated structure 10.

In the laminated structure 10 according to the exemplary embodiment, the modified layer 21N has, on the surface 21Na thereof, a needle-like structure N in a sectional view (FIGS. 2A and 2B). The needle-like structure N can produce an anchor effect, and thus, an effect of enhancing the adhesion between the resin substrate 20 and the metal layer 40 is expected.

According to an exemplary aspect of the present disclosure, the “needle-like structure N” refers to a protrusion in an elongated shape, which can be confirmed in a TEM image at a magnification of 300,000 times, with the aspect ratio (Nt/Nw) of a length Nt to a width Nw being 2 or more, and with a length Nt of 30 nm or more.

According to an exemplary aspect of the present disclosure, it is noted that the term “needle-like structure N” is not limited to a structure with a sharp tip. Examples of the needle-like structure N include, as schematically shown in FIG. 2B, various forms such as a tapered form like a needle-like structure N1 and a form that is rounded at the tip like a needle-like structure N2. In addition, the longitudinal direction may be substantially perpendicular to the surface 21Na of the modified layer 21N like the needle-like structure N1, or may be inclined with respect to the surface 21N.

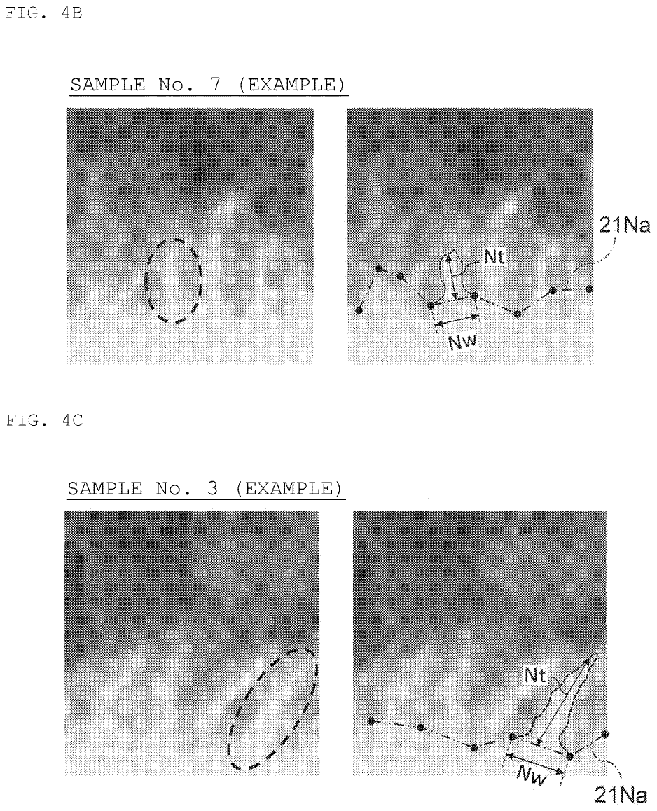

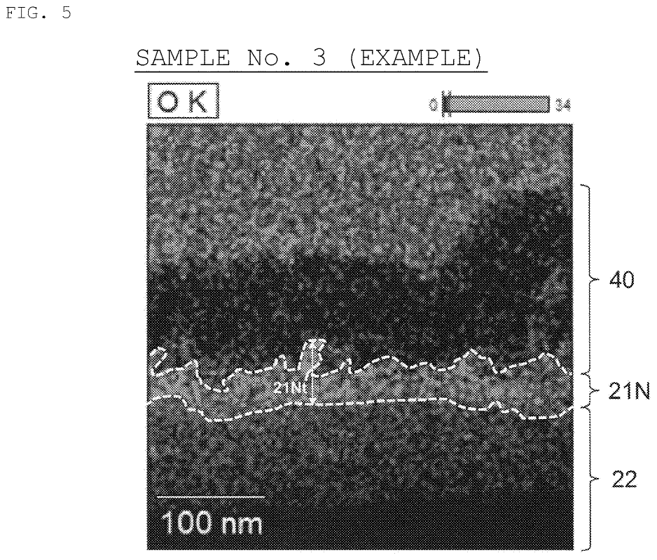

The surface 21Na of the modified layer 21N is illustrated as a flat surface in FIG. 2B but is not a flat surface in practice in some cases (see FIGS. 4A to 4C). In such a case, the curved surface is specified from the position of the “valley” between adjacent needle-like structures N, and the surface 21Na of the modified layer 21N is defined. Specifically, the lowest position (the point at which the positive or negative of the slope of the tangent line is changed, that is, the inflection point) of the valley is marked with a dot on the surface 21Na of the modified layer 21N observed in a TEM image at a magnification of 300,000 times. Each of all valleys in the field of view is marked with a dot (black dots in FIGS. 4A to 4C), and a straight line (line segment) is drawn between the two adjacent points (two-dot chain lines in FIGS. 4A to 4C). Each of the line segments has at least one of the end points in contact with another line segment, and thus, the line segments form a continuous polygonal line. This polygonal line is defined as “the surface 21Na of the modified layer 21N”. As will be described later, the length of each line segment corresponds to the width Nw of the needle-like structure N separated from the modified layer 21N by the line segment.

According to the exemplary aspect, there is assumed to be “one” valley between the adjacent needle-like structures N, and one valley is assumed to be marked with one dot. In a case where one valley has multiple inflection points, only the inflection point at the lowest position among the inflection points is marked with a dot.

For the work of marking the valley with a dot, the valley may be visually confirmed by a human and then manually marked with a dot or may be automatically marked with a dot with image analysis software.

A method for measuring the width Nw and the length Nt of the needle-like structure N (N1 to N3) will be described according to an exemplary aspect.

For purposes of this disclosure, the width Nw of the needle-like structure N is defined as the distance between dots attached to valleys on both sides of the needle-like structure N as a target. As can be seen from the foregoing description and FIGS. 4A to 4C, the width Nw of the needle-like structure N corresponds to the length of a line segment that separates the needle-like structure N as a target from the modified layer 21N (this is referred to as a “line segment at the base of the needle-like structure N”) among multiple line segments drawn for defining the surface 21Na of the modified layer 21N.

Moreover, the length Nt of the needle-like structure N (N1 to N3) is the distance from the intersection (typically at or near the apex of the needle-like structure N) of the axis (longitudinal axis) in the longitudinal direction of the needle-like structure N and the contour of the needle-like structure N to the intersection of the longitudinal axis and the line segment at the base of the needle-like structure N. It is to be noted that the longitudinal axis is a line extending in the longitudinal direction of the needle-like structure N and drawn so as to pass through approximately the center of the width of the needle-like structure N. The longitudinal axis can be visually confirmed and manually drawn by a human.

TEM images of actual needle-like structures N are shown in FIGS. 4A to 4C. In each of the drawings, the TEM image on the left side shows the needle-like structure N (i.e., surrounded by a dashed ellipse) to be analyzed, and the TEM image on the right side shows the width Nw and the length Nt, with the contour of the needle-like structure N drawn with a dashed line.

As described above, the needle-like structure N has an aspect ratio Nt/Nw of 2 or more, and furthermore, the length Nt is preferably 30 nm or more. The anchor effect achieved by the needle-like structure N is improved, and thus, the adhesion between the resin substrate 20 and the metal layer 40 can be further enhanced.

It is noted that the resin substrate 20 is not particularly limited, and can contain, for example, one or more selected from the group consisting of an acrylonitrile-butadiene-styrene (ABS), a polycarbonate/acrylonitrile-butadiene-styrene (PC/ABS), an acrylonitrile-styrene-acrylate (ASA), a silicon-based composite rubber-acrylonitrile-styrene (SAS), a noryl, polypropylene, polycarbonate (PC), a polycarbonate-based alloy, an acrylonitrile-styrene, a polyacetate, a polylactic acid, a polystyrene, a polyamide, an aromatic polyamide, a polyethylene, a polyether ketone, a polyethylene terephthalate, a polybutylene terephthalate, a polysulfone, a polyether ether sulfone, a polyether imide, a modified polyphenylene ether, a polyphenylene sulfide, a polyphenylene oxide, polyamide, polyimide, modified polyimide, an epoxy resin, a cycloolefin polymer, a polynorbornene, a perfluoroalkoxy fluorine polymer, a polytetrafluoroethylene, and a vinylidene fluoride, a vinyl resin, a phenol resin, polyacetal, nylon, a liquid crystal polymer, and the like, and copolymers of the respective polymers.

According to an exemplary aspect, the metal layer 40 of the laminated structure 10 preferably contains one or more selected from the group consisting of Fe, V, Ni, Ti, Ca, Ag, Zn, Al, Mg, Rh, Pt, Au, Pd, Co, Mn, and Cu.

### (Method for Manufacturing Laminated Structure 10)

Next, a method for manufacturing the laminated structure 10 will be described according to an exemplary aspect.

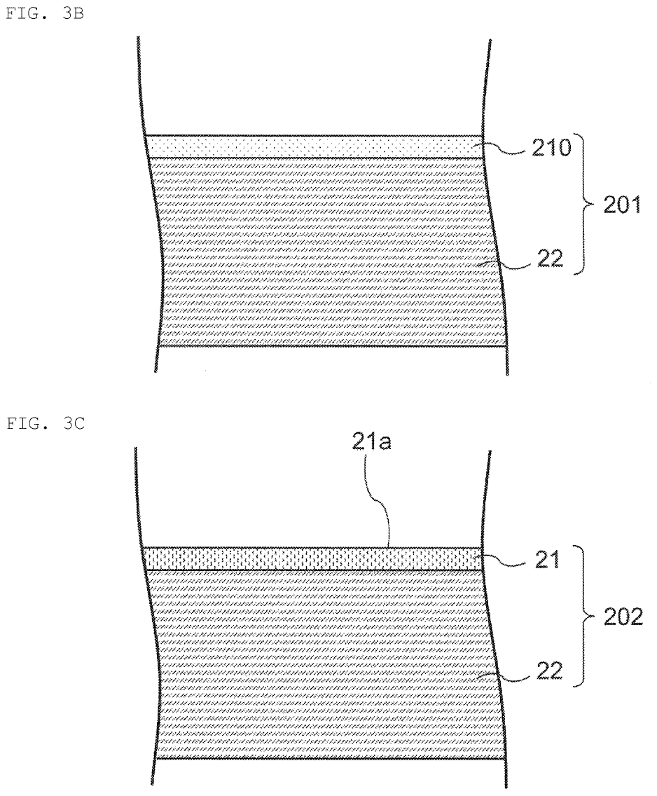

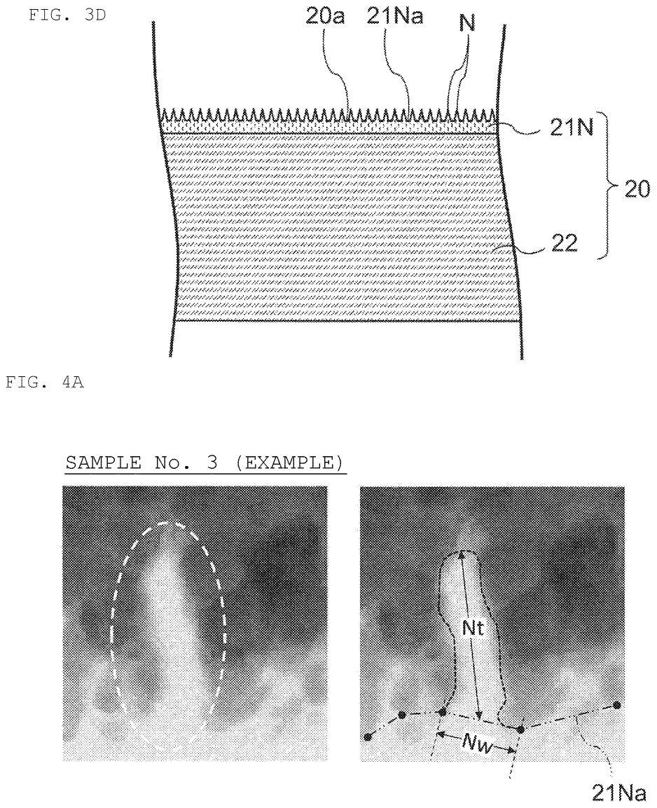

FIGS. 3A to 3D are schematic enlarged sectional views for explaining a method for manufacturing the laminated structure 10.

The method for manufacturing the laminated structure 10 includes treating a surface 200a of a resin substrate 200 to form a surface-treated resin substrate 201 including a substrate body 22 and a softened layer 210 that covers the substrate body 22; heat-treating the surface-treated resin substrate 201 to cure the softened layer 210 and then form a modified layer 21; dissolving a part of a surface 21a of the modified layer 21 to form a needle-like structure; and forming a metal layer 40 on a surface 21Na of the modified layer 21N including the needle-like structure N by a plating method. The method will generally be described with respect to the following three steps.

### Step 1) Surface Treatment Step

The resin substrate 200 is prepared, and the surface 200a is subjected to a surface treatment (softening treatment). Thus, the surface-treated resin substrate 201 including the substrate body 22 and the softened layer 210 that covers the substrate body 22 is obtained.

An example of the surface treatment is ultraviolet irradiation (UV irradiation). The surface 200a of the resin substrate 200 is irradiated with an ultraviolet ray (UV) to cut some of chemical bonds of molecules in the resin at the surface 200a (FIG. 3A). By cutting chemical bonds at the surface 200a of the resin substrate 200 as described above (this may be referred to as modification of the surface 200a (e.g., surface modification)), the softened layer 210 is formed (FIG. 3B). As will be described in detail below, introducing an oxygen-based functional group into a part where chemical bonds of polymer chains (main chains and side chains) are broken increases the oxygen element concentration of the softened layer 210, and thus the modified layer 21N formed from the softened layer 210. Thus, the oxygen element concentration of the modified layer 21N can be an index for knowing the degree of breaking the chemical bond of the polymer chain in the surface treatment step.

Two mechanisms are assumed for the breakage of the chemical bonds.

First, chemical bonds of molecules in the resin are considered broken by the energy of UV with which the resin substrate 200 is irradiated. This breakage mechanism may be referred to as “direct breakage” in an exemplary aspect.

As another mechanism, it is also conceivable that chemical bonds of molecules in the resin are broken by ozone produced from oxygen in the air by the energy of UV with which the resin substrate 200 is irradiated. This breakage mechanism may be referred to as “indirect breakage” in an exemplary aspect.

Furthermore, the chemical bond breakage includes the breakage of chemical bonds of main chains of molecules (polymer) of the resin forming resin substrate 200, and the breakage of chemical bonds of side chains of the polymer.

When the chemical bonds of the main chains are broken, the main chains are assumed to remain divided, with some of the broken sites recombined to regenerate the original chemical bonds, and with functional groups introduced into the other breakage sites. Examples of the functional groups include a functional group having a —O—H structure at the end, such as an acid group and a carboxyl group.

As a mechanism by which the functional groups (in particular, a functional group having a —O—H structure) are introduced, in the case of direct breakage, radicals generated by the breakage of chemical bonds in the resin (mainly, the surface 200a of the resin substrate 200) react with oxygen in the air, thereby introducing O into the broken sites of the chemical bonds, and the breakage sites further react with moisture in the air, thereby introducing an —O—H structure.

In the case of indirect breakage, when chemical bonds of molecules in the resin are broken by the ozone, O is introduced into the broken sites of the chemical bonds, and the breakage sites further react with moisture in air, thereby introducing an —O—H structure.

Also, when the chemical bonds of the side chains are broken, functional groups can be introduced into the broken sites by the same mechanism as in the case of the main chains.

At the surface 200a of the resin substrate 200, chemical bonds of molecules in the resin are broken (in particular, the chemical bonds of the main chains are broken), thereby reducing the strength of the surface 200a (softening the surface 200a).

According to an exemplary aspect, the irradiation time and irradiation intensity of the UV irradiation are selected so that the softened layer 210 with appropriate softness is formed from the surface 200a to an appropriate depth, and so that the oxygen-based functional group is introduced in a sufficient amount into the softened layer 210. For example, the irradiation time can be 10 seconds to 30 minutes, and the irradiation intensity can be 5 to 250 mW/cm².

It is noted that if the UV irradiation time is excessively short, the insufficient introduction amount of functional groups introduced into the softened layer 210 can insufficiently improve the oxygen element concentration in the modified layer 21N, and the effect of hardening the surface may be insufficient even if the next heat treatment step is performed. In contrast, if the UV irradiation time is excessively long, the surface 200a of the resin substrate 200 is excessively damaged (e.g., chemical bonds in the polymer are excessively broken), and there is a possibility that the surface strength will remain decreased without returning even after the heating step is performed.

Examples of the method for the surface modification include plasma treatment, corona treatment, and electron beam irradiation in addition to UV irradiation, and the surface modification can be performed by employing one or more of these methods. Any of the methods is capable of breaking some of chemical bonds of molecules of the resin material present at the surface 200a to modify the surface 210a of the resin substrate 200. Thus, the softened layer 210 is formed at the surface 200a of the resin substrate 200 to obtain the surface-treated resin substrate 201 including the softened layer 210 and the substrate body 22, which is not softened (FIG. 3B).

### Step 2) Heat Treatment Step

Heating the surface-treated resin substrate 201 causes the softened layer 210 to be cured to form the modified layer 21 (FIG. 3C). Thus, the resin substrate 202 including the modified layer 21 is formed. At this stage, the modified layer 21 includes no needle-like structure N on the surface 21a.

No treatment for curing the softened layer not performed in Patent Documents 5 to 8. Accordingly, in step 3) described later, the softened layer 210 can be removed, and it is difficult to achieve stable linkage between the resin substrate 20 and the metal layer 40.

The reason why the modified layer 21, which is harder than the original resin substrate 200, can be formed by heat-treating the softened layer 210 is not clear, but the following mechanism is assumed.

As described above, the chemical bonds are broken by the surface treatment step in step 1), and a functional group including an —O—H structure can be introduced into the broken sites. Thereafter, the subsequent heat treatment causes dehydration condensation between two adjacent functional groups and thereby forming a new bond between the functional groups.

In this regard, the new bond formed between the functional groups introduced into the broken sites of the main chains can be considered as a bond formed by once breaking the bonds of the main chains, which are present before the breakage, and then bonding the broken sites again with the functional group inserted between the broken sites (that is, main chain recombination).

In contrast, the new bond formed between the functional groups introduced into the broken sites of the side chains is a “bond between side chains”, which is not present before the breakage. A more specific image is as follows. While the side chain is bonded to and terminated with a functional group in a molecule in the resin, the chemical bond with the functional group is broken, and then instead, a new bond is formed between the broken site, and the broken site of the side chain of another molecule. More specifically, the side chain terminated with the functional group is bonded to the side chain of the adjacent molecule. Accordingly, after the heat treatment step, the number of chemical bonds between molecules is increased as compared with that before the surface treatment step, thereby increasing the strength of the resin.

By such a mechanism, the number of chemical bonds between molecules is, as compared with that before the surface treatment step, considered increased at the surface of the resin material, as a result, allowing the modified layer 21, which is harder than the substrate body 22 (formed from an unmodified resin material), to be formed.

It is also noted that the heat treatment temperature needs to be lower than the melting point of the resin material forming the surface-treated resin substrate 201, and can be, for example, 60° C. to 300° C. The heating time can be appropriately set in accordance with the heating temperature, and is, for example, 1 minute to 120 minutes.

It is noted that according to an exemplary aspect, the heat treatment step is performed before step 3): metal layer formation step, which will be described later. The softened layer 210 subjected to no heat treatment has low resistance to a plating solution. Thus, if step 3): metal layer formation step is performed before the heat treatment step to bring the softened layer 210 into contact with a chemical liquid (for example, a plating solution in an electroless plating bath), the softened layer 210 may be mostly eluted into the plating solution. The needle-like structure N is formed by partial elution of the modified layer 21, and it is thus difficult to form the needle-like structure N if step 3): metal layer formation step is performed with the softened layer 210, which is to be mostly eluted, as it is.

Performing step 2) before the metal layer formation process (plating process) in step 3): metal layer formation step to improve the surface strength of the resin substrate in advance makes it possible to avoid a situation in which the softened layer 210 is mostly eluted into the plating solution in step 3): metal layer formation step. More specifically, the modified layer 21 (oxygen enrichment layer) partially remains (e.g., needle-like) on the surface of the resin substrate 20 after step 3): metal layer formation step, thus achieving the effect of improving the adhesion between the resin substrate 20 and the metal layer 40 with the oxygen-based functional group. In addition, the modified layer 21 is partially eluted into the plating solution, thereby allowing the modified layer 21N with the needle-like structure N to be formed.

### Step 3) Metal Layer Formation Step

The metal layer 40 is formed by a plating method so as to cover the surface 21a of the modified layer 21 (FIG. 3D). The metal layer 40 can be formed by electroless plating in an exemplary aspect.

When the resin substrate 202 (FIG. 3C) (including the modified layer 21) is immersed in a plating bath for electroless plating, the surface 21a of the modified layer 21 is partially dissolved to form the needle-like structure N (FIG. 3D). Then, the metal layer 40 is formed on the surface 21Na of the modified layer 21N including the needle-like structure N (FIG. 2A).

To the plating solution, the plating conditions, and the like for use in the electroless plating, known ones can be applied. Before performing the electroless plating, the surface 20a of the resin substrate 20 (i.e., the surface 21a of the modified layer 21) is preferably pretreated by a known pretreatment method such as catalyst application.

Moreover, the metal layer 40 may further include an electrolytic plating layer that covers the electroless plating layer according to an exemplary aspect.

In this way, the laminated structure 10 shown in FIG. 2A can be manufactured.

### EXAMPLES

Various tests were performed with the use of samples prepared under the following conditions.

### (Preparation of Samples)

As the resin substrate 200, COP (cycloolefin polymer) sheets and LCP (liquid crystal polymer) sheets of 50 mm in length×50 mm in width×0.1 mm in thickness were prepared and used as resin substrate samples. Laminated structures 10 were prepared from the resin substrate samples in accordance with the procedure shown in FIGS. 3A to 3C.

Samples for measurement were prepared in accordance with the treatment conditions for each of the samples in Table 1. Detailed conditions for each treatment are shown in Tables 2 to 5.

### (Sample Nos. 1 to 5)

For sample Nos. 1 to 5, the COP sheets were used as the resin substrate 200. In the case of using the COP sheets, the sheets were basically subjected to a treatment A (UV irradiation), a treatment B1 (atmospheric heating treatment), a treatment C (electroless plating), and a treatment D (electrolytic plating). However, for sample No. 1, the treatment B1 was skipped as described later.

The samples Nos. 3 and 4 were examples, for which each sample (laminated structure) was prepared by a manufacturing process satisfying the conditions according to the present embodiment. As listed in Table 1, the sheets were subjected to the treatment A (UV irradiation) for 15 minutes or 20 minutes, and subjected to the treatment B1 (atmospheric heating treatment), the treatment C (electroless plating), and the treatment D (electrolytic plating). Further, in the treatment C (electroless plating), the sheets were subjected to treatment Nos. C1 to C5 in Table 4 in this order, and in the treatment D (electrolytic plating), subjected to treatment Nos. D1 to D2 in Table 5 in this order.

For the metal layer 40, the electroless plating (treatment C) and the electrolytic plating (treatment D) were performed to form a two-layer structure. The metal element contained in the metal layer 40 was mainly Cu.

The sample No. 1 was a comparative example, for which a sample (laminated structure) was prepared under the same conditions as for the sample Nos. 3 and 4 except for performing no treatment B1 (atmospheric heating treatment).

For the sample No. 2, a sample (laminated structure) was prepared under the same conditions as for the sample Nos. 3 and 4 except for the treatment A (UV irradiation) for 5 minutes.

For the sample No. 5, a sample (laminated structure) was prepared under the same conditions as for the sample Nos. 3 and 4 except for the treatment A (UV irradiation) for 30 minutes.

### (Sample Nos. 6 to 9)

For sample Nos. 6 to 9, the LCP sheets were used as the resin substrate 200. In the case of using the LCP sheets, the sheets were basically subjected to the treatment A (UV irradiation), a treatment B2 (vacuum heating treatment), the treatment C (electroless plating), and the treatment D (electrolytic plating). However, for the sample No. 6, the treatment B2 was skipped as described later.

The samples Nos. 7 and 8 were examples, for which samples (laminated structures) were prepared by a manufacturing process satisfying the conditions according to the present embodiment. As listed in Table 1, the sheets were subjected to the treatment A (UV irradiation) for 15 minutes or 20 minutes, and subjected to the treatment B2 (vacuum heating treatment), the treatment C (electroless plating), and the treatment D (electrolytic plating).

The sample No. 6 was a comparative example, for which a sample (laminated structure) was prepared under the same conditions as for the sample Nos. 7 and 8 except for performing no treatment B2 (vacuum heating treatment).

The sample No. 9 was a comparative example, for which a sample (laminated structure) was prepared under the same conditions as for the sample Nos. 7 and 8 except for the treatment A (UV irradiation) for 30 minutes.

### (1. XPS Measurement)

XPS measurement for each sample was performed under the following conditions.

First, the metal layer 40 was removed by wet etching from the sample including the metal layer 40 to expose the surface 20a of the resin substrate 20 (corresponding to the surface 21Na of the modified layer 21N).

XPS measurement of the exposed surface was performed under the following conditions, with a rectangular range of 1000 μm×200 μm as a measurement region at an arbitrary position on the surface 21Na, with the use of an XPS spectroscopic analyzer (Quantes manufactured by ULVAC-PHI, Inc.).
Takeoff Angle of Photoelectron: 45°
X-ray beam diameter: 100 μmφ
Pass Energy of Photoelectron: 224 eV

### (2. Sectional TEM-EDX)

Each of the samples was cut in the thickness direction, and from the section, a thin piece sample was prepared, and subjected to TEM-EDX analysis under the following conditions.
FE-TEM/EDX (JEOL JEM-F200/Noran system 7)
Preparation of Thin Piece by FIB Lift-Out Method and Observation thereof
Acceleration Voltage: 200 kV
Magnification: 300,000 times
Field of View: 400 nm×400 nm

It was determined that “there was a needle-like structure” in a case where one or more needle-like structures N (protrusions of 2 or more in aspect ratio (Nt/Nw) and of 30 nm or more in length Nt) were observed, whereas it was determined that “there was no needle-like structure” in a case where no needle-like structure N was present.

FIGS. 4A and 4C show TEM images of the sample No. 3, which were observed at different positions. FIG. 4B shows a TEM image of the sample No. 7.

FIG. 5 shows element mapping of the oxygen (O) element, which was obtained by the EDX analysis of the sample No. 3.

### (3. Adhesion Force: 90° Peeling Evaluation)

For measuring the adhesion between the resin substrate 20 and the metal layer 40, the peeling strength of the metal layer 40 was measured for each of the samples. The measurement was performed in accordance with JIS C 6471: 1995 and JIS C 6481: 1996.

The measurement conditions and the measurement procedure were as follows:
Measuring Apparatus: RTF-1210 manufactured by A & D Company, Limited
Measurement Method: peel copper foil width of 10 mm, peeling in 90° direction, peeling rate of 50 mm/min
Measurement Procedure
   (1) Each sample was prepared in accordance with the procedure described above. However, regarding the electrolytic plating (step D), the plating time was appropriately adjusted for thick electrolytic copper plating. The target film thickness of the electrolytic copper plating was 30 μm.
   (2) Two parallel slits were made in the metal layer 40 with a cutter. The distance between the two slits was adjusted to be 10 mm, and with the copper foil (10 mm in width) between the slits being left, the copper foil on the both sides was removed. One end of the copper foil was held with a jig and pulled in a 90° direction with respect to the surface of the resin substrate to perform a peel test.

The measurement results are shown in Table 1.

TABLE 1

| | | | | Oxygen | Presence or | | |
|---|---|---|---|---|---|---|---|
| | | Type of | | Element | Absence of | Adhesion | |
| Sample | | Resin | Treatment | Concentration | Needle-like | Force | |
| No. | | Substrate | Conditions | (atom %) | Shape | (kN/m) | Remarks |
| 1 | Comparative | COP | treatment A (UV | 10.5 | absent | 0.02 | NG |
| | Example | | irradiation): 15 min | | | | |
| | | | → no treatment B1 | | | | |
| | | | → treatment C | | | | |
| | | | (electroless plating) | | | | |
| | | | → treatment D | | | | |
| | | | (electrolytic plating) | | | | |
| 2 | Comparative | COP | treatment A (UV | 14.0 | present | 0.05 | NG |
| | Example | | irradiation): 5 min | | | | |
| | | | → treatment B1 | | | | |
| | | | (atmospheric heating | | | | |
| | | | treatment) | | | | |
| | | | → treatment C | | | | |
| | | | (electroless plating) | | | | |
| | | | → treatment D | | | | |
| | | | (electrolytic plating) | | | | |
| 3 | Example | COP | treatment A (UV | 17.1 | present | 1.00 | G |
| | | | irradiation): 15 min | | | | |
| | | | → treatment B1 | | | | |
| | | | (atmospheric heating | | | | |
| | | | treatment) | | | | |
| | | | → treatment C | | | | |
| | | | (electroless plating) | | | | |
| | | | → treatment D | | | | |
| | | | (electrolytic plating) | | | | |
| 4 | Example | COP | treatment A (UV | 30.0 | present | 0.17 | G |
| | | | irradiation): 20 min | | | | |
| | | | → treatment B1 | | | | |
| | | | (atmospheric heating | | | | |
| | | | treatment) | | | | |
| | | | → treatment C | | | | |
| | | | (electroless plating) | | | | |
| | | | → treatment D | | | | |
| | | | (electrolytic plating) | | | | |
| 5 | Comparative | COP | treatment A (UV | 33.1 | present | 0.01 | NG |
| | Example | | irradiation): 30 min | | | | |
| | | | → treatment B1 | | | | |
| | | | (atmospheric heating | | | | |
| | | | treatment) | | | | |
| | | | → treatment C | | | | |
| | | | (electroless plating) | | | | |
| | | | → treatment D | | | | |
| | | | (electrolytic plating) | | | | |
| 6 | Comparative | LCP | treatment A (UV | 20.0 | absent | 0.02 | NG |
| | Example | | irradiation): 15 min | | | | |
| | | | → no treatment B2 | | | | |
| | | | → treatment C | | | | |
| | | | (electroless plating) | | | | |
| | | | → treatment D | | | | |
| | | | (electrolytic plating) | | | | |
| 7 | Example | LCP | treatment A (UV | 24.0 | present | 0.40 | G |
| | | | irradiation): 15 min | | | | |
| | | | → treatment B2 (vacuum | | | | |
| | | | heating treatment) | | | | |
| | | | → treatment C | | | | |
| | | | (electroless plating) | | | | |
| | | | → treatment D | | | | |
| | | | (electrolytic plating) | | | | |
| 8 | Example | LCP | treatment A (UV | 29.8 | present | 0.30 | G |
| | | | irradiation): 20 min | | | | |
| | | | → treatment B2 (vacuum | | | | |
| | | | heating treatment) | | | | |
| | | | → treatment C | | | | |
| | | | (electroless plating) | | | | |
| | | | → treatment D | | | | |
| | | | (electrolytic plating) | | | | |
| 9 | Comparative | LCP | treatment A (UV | 31.1 | present | 0.01 | NG |
| | Example | | irradiation): 30 min | | | | |
| | | | → treatment B2 (vacuum | | | | |
| | | | heating treatment) | | | | |
| | | | → treatment C | | | | |
| | | | (electroless plating) | | | | |
| | | | → treatment D | | | | |
| | | | (electrolytic plating) | | | | |

TABLE 2
Surface Treatment Step (UV Irradiation)

| | | | | | |
|---|---|---|---|---|---|
| Treat- | | | | | |
| ment | | UV | UV | | |
| No | Treatment | Illuminance | Time | Apparatus | Remarks |

| | | | | |
|---|---|---|---|---|
| A | UV | 8.5 mW/cm2 | 5 to | MHU-110BK |
| | irradiation | | 30 min | manufactured |
| | | | | by Multiply |
| | | | | Corporation |

TABLE 3
Heat Treatment Step

| Treatment | | Treatment | Treatment |
|---|---|---|---|
| No. | Treatment | Temperature | Time |
| B1 | atmospheric | 120° C. | 60 min |
| | heating | | |
| | treatment | | |
| B2 | vacuum heating | 200° C. | 60 min |
| | treatment | | |

TABLE 4
Metal Layer Formation Step (Electroless Plating Treatment)

| | | Composition and | | | | | | |
|---|---|---|---|---|---|---|---|---|
| Treatment | | Concentration of | | | Bath | Treatment | | |
| No. | Treatment | Agent Used | | | Temperature | Time | | Remarks |
| C1 | conditioner | Top LECS | 80 | ml/L | 50° C. | 5 | min | — |
| | | Conditioner | | | | | | |
| C2 | predip | Top LECS Predip M | 50 | ml/L | 25° C. | 1 | min | — |
| C3 | catalyst | Top LECS Catalyst A | 50 | ml/L | 40° C. | 5 | min | alkali |
| | application | Top LECS Catalyst B | 50 | ml/L | | | | catalyst |
| C4 | activation | Top LECS | 8 | ml/L | 25° C. | 5 | min | — |
| | | Accelerator | | | | | | |
| | | boric acid | 6 | g/L | | | | |
| C5 | electroless | Top LECS Copper A | 50 | ml/L | 32° C. | 10 | min | Rochelle |
| | Cu plating | Top LECS Copper M | 80 | ml/L | | | | salt- |
| | (containing | Top LECS Copper C | 15 | ml/L | | | | based Cu |
| | Ni) | electroless copper | 3 | ml/L | | | | plating |
| | | R-N | | | | | | |

TABLE 5
Metal Layer Formation Step (Electrolytic Plating Treatment)

| | | Composition and | | | | | | |
|---|---|---|---|---|---|---|---|---|
| Treatment | | Concentration of | | | Bath | Current | | |
| No. | Step | Agent Used | | | Temperature | density | Time | |
| D1 | pickling | 98% sulfuric acid | 50 | ml/L | 25° C. | — | 5 | min |
| D2 | electrolytic | copper sulfate | 150 | g/L | 35° C. | 5ASD | 32 | min |
| | copper | pentahydrate | | | | | | |
| | plating | 98% sulfuric acid | 200 | g/L | | | | |
| | | chloride ion | 100 | mg/L | | | | |
| | | leveler | 12 | ml/L | | | | |
| | | brightener | 8 | ml/L | | | | |

The sample Nos. 3, 4, 7, and 8 were examples prepared by the manufacturing method according to the exemplary embodiment, and each of the samples had an oxygen element concentration of 17 atom % or more and of 30 atom % or less at the surface 21a of the modified layer 21, also had a needle-like structure N formed. As a result, the samples were each high in adhesion between the resin substrate 20 and the metal layer 40.

The sample Nos. 1 and 6 each had no hard modified layer 21 formed while the softened layer 210 was formed at the surface 20a of the resin substrate 20, because the heat treatment step after the UV irradiation was not performed at the time of preparing each of the samples. Thus, the softened layer 210 was all removed in the metal layer formation step.

The sample No. 1 had a low oxygen element concentration at the surface 20a of the resin substrate 20 and had no needle-like structure N formed, because the softened layer 210 was all removed.

In contrast, for the sample No. 6, the LCP sheet containing an oxygen element was used as the resin substrate 200, and thus, the oxygen element concentration at the surface 20a of the resin substrate 20 apparently satisfies the requirement according to the exemplary embodiment. However, no needle-like structure N was formed, because no softened layer 210 was present.

As a result, the sample Nos. 1 and 6 were low in adhesion between the resin substrate 20 and the metal layer 40.

The sample No. 2 was, because of the excessively short UV irradiation time at the time of preparing the sample, insufficient in the amount of the oxygen-based functional group introduced into the softened layer 210, and capable of insufficiently improving the oxygen element concentration at the surface 21Na of the modified layer 21N. As a result, the sample was low in adhesion between the resin substrate 20 and the metal layer 40, while the modified layer 21 was present at the surface 20a of the resin substrate 20, with a needle-like structure N formed.

The sample Nos. 5 and 9 were, because the excessively long UV irradiation time at the time of preparing each of the samples, excessive in the amount of the oxygen-based functional group introduced into the softened layer 210 (that is, excessively high in the oxygen element concentration at the surface 21Na of the modified layer 21N), and the softened layer 210 was excessively damaged. Thus, even performing the subsequent heat treatment step failed to sufficiently improve the hardness. As a result, the samples were not sufficient in the hardness of the modified layer 21 and low in adhesion between the resin substrate 20 and the metal layer 40, while the modified layer 21 was present at the surface 20a of the resin substrate 20 with a needle-like structure N formed.

### DESCRIPTION OF REFERENCE SYMBOLS

10: Laminated structure
20: Resin substrate
21N: Modified layer
22: Substrate body
40: Metal layer

1. A laminated structure comprising:
a resin substrate including a substrate body and a modified layer that covers a surface of the substrate body; and
a metal layer that covers a surface of the modified layer,
wherein the surface of the modified layer has an oxygen element concentration of 17 atom % or more and 30 atom % or less,
wherein, in a sectional view, the modified layer has a needle-like structure.

2. The laminated structure according to claim 1, wherein the oxygen element concentration at the surface of the modified layer is higher than an oxygen element concentration of the substrate body.

3. The laminated structure according to claim 1, wherein the modified layer has a thickness in the sectional view that is 10 nm or more and 5000 nm or less.

4. The laminated structure according to claim 1, wherein the resin substrate contains one or more selected from the group consisting of an acrylonitrile-butadiene-styrene (ABS), a polycarbonate/acrylonitrile-butadiene-styrene (PC/ABS), an acrylonitrile-styrene-acrylate (ASA), a silicon-based composite rubber-acrylonitrile-styrene (SAS), a noryl, a polypropylene, a polycarbonate (PC), a polycarbonate-based alloy, an acrylonitrile-styrene, a polyacetate, a polylactic acid, a polystyrene, a polyamide, an aromatic polyamide, a polyethylene, a polyether ketone, a polyethylene terephthalate, a polybutylene terephthalate, a polysulfone, a polyether ether sulfone, a polyether imide, a modified polyphenylene ether, a polyphenylene sulfide, a polyphenylene oxide, a polyamide, a polyimide, a modified polyimide, an epoxy resin, a cycloolefin polymer, a polynorbornene, a perfluoroalkoxy fluorine polymer, a polytetrafluoroethylene, and a vinylidene fluoride, a vinyl resin, a phenol resin, a polyacetal, a nylon, a liquid crystal polymer, and copolymers of the polymers.

5. The laminated structure according to claim 1, wherein the needle-like structure comprises a plurality of protrusions that each have an elongated shape.

6. The laminated structure according to claim 5, wherein the elongated shape of the plurality of protrusions is in a longitudinal direction that is substantially perpendicular to the surface of the modified layer.

7. The laminated structure according to claim 1, wherein the needle-like structure has an aspect ratio of a length to a width of 2 or more, and a length of at least 30 nanometers (nm).

8. The laminated structure according to claim 1, wherein the metal layer contains one or more selected from the group consisting of Fe, V, Ni, Ti, Ca, Ag, Zn, Al, Mg, Rh, Pt, Au, Pd, Co, Mn, and Cu.

9. The laminated structure according to claim 1, wherein the modified layer has a higher oxygen element concentration throughout than the substrate body.

10. The laminated structure according to claim 1, wherein the surface of the substrate body is entirely covered with the modified layer.

11. The laminated structure according to claim 1, wherein the metal layer comprises:
an electroless plating layer, and
an electrolytic plating layer that covers the electroless plating layer.

12. The laminated structure according to claim 1, wherein the oxygen element concentration is an element concentration of oxygen defined by a total element concentration of oxygen, carbon, nitrogen, and copper at the surface of the modified layer as 100 atom %.

13. A method for manufacturing a laminated structure, the method comprising:
treating a surface of a resin substrate to form a surface-treated resin substrate that includes a substrate body and a softened layer that covers the substrate body;
heat-treating the surface-treated resin substrate to cure the softened layer and form a modified layer;
dissolving a part of a surface of the modified layer to form a needle-like structure; and
forming a metal layer on a surface of the modified layer including the needle-like structure,
wherein the modified layer has an oxygen element concentration of 17 atom % or more and 30 atom % or less.

14. The method for manufacturing the laminated structure according to claim 13, wherein the treating of the surface of the resin substrate includes subjecting the surface of the resin substrate to one or more treatments selected from the group consisting of UV irradiation, plasma treatment, corona treatment, and electron beam irradiation.

15. The method for manufacturing the laminated structure according to claim 13, wherein the treating of the surface of the resin substrate includes ultraviolet irradiation having an irradiation time of 10 seconds to 30 minutes and an irradiation intensity of 5 to 250 mW/cm².

16. The method for manufacturing the laminated structure according to claim 13, wherein the heat-treating of the surface-treated resin substrate is performed at a temperature of 60° C. to 300° C.

17. The method for manufacturing the laminated structure according to claim 13, wherein the heat-treating of the surface-treated resin substrate is performed for a heating time of 1 minute to 120 minutes.

18. The method for manufacturing the laminated structure according to claim 13, wherein the forming of the metal layer comprises electroless plating and forming an electrolytic plating layer on the metal layer.

19. The method for manufacturing the laminated structure according to claim 13, wherein the treating of the surface of the resin substrate further comprises introducing an oxygen-based functional group into a site where a chemical bond of a polymer chain in the resin substrate is broken to increase the oxygen element concentration of the modified layer.

20. The method for manufacturing a laminated structure according to claim 13, wherein forming the metal layer comprises partially dissolving by immersion the surface of the modified layer in a plating bath for electroless plating to form the needle-like structure.
